(19) United States
(12) Patent Application Publication
(10) Pub. No.: US 2026/0080392 A1
(43) Pub. Date: Mar. 19, 2026

(54) Seamless Authentication for Multi-Profile Mobile Application

(71) Applicant: Bank of America Corporation, Charlotte, NC (US)

(72) Inventors: Siten Sanghvi, Westfield, NJ (US); Naga Vamsi Krishna Akkapeddi, Charlotte, NC (US)

(21) Appl. No.: 18/884,203

(22) Filed: Sep. 13, 2024

(51) Int. Cl. G06Q 40/02; H04L 9/40

(52) U.S. Cl. CPC G06Q 20/3674

(57) ABSTRACT

Arrangements for providing seamless authentication in a multi-profile mobile application are provided. A computing platform may receive a request for a primary user to access a mobile wallet application. The primary user may be authenticated to the application to access the primary user profile of the application. While the primary user is logged in to the application, the platform may receive a request to access a secondary user profile of the application. The platform may generate and send a user interface including available secondary user profiles. The platform may receive selection of a first secondary user profile and may retrieve authentication requirements associated with the first secondary user profile. The platform may request authentication data based on the requirements. The platform may receive response data and may authenticate the secondary user to the secondary user profile. The platform may receive selection of a transaction and may process the transaction.

### BACKGROUND

Aspects of the disclosure relate to electrical computers, systems, and devices for seamless authentication for a multi-profile mobile application.

In current mobile application technology, such as mobile wallet application technology, a mobile device is generally designed to cater to a single user profile for the mobile wallet application on that device. However, this can be limiting when devices are shared or used by multiple family members or other users. Further, conventional systems do not provide portability of mobile wallet applications to different devices without setting up the mobile wallet application (e.g., providing payment devices, logging in, and the like). Accordingly, aspects described herein provide for a central hub to manage user profiles of a primary user of a computing device, and one or more secondary users of the mobile device, to enable seamless authentication and access to a mobile wallet via a single computing device.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with seamless authentication in a multi-profile mobile application environment.

In some examples, a computing platform may receive registration data including identification of a user device, a primary user of the user device, and one or more secondary users of the user device. In some examples, mobile wallet application profiles for the primary user and the one or more secondary users may be received and stored. The profiles may be partitioned to ensure data privacy.

The computing platform may receive a request for a primary user to access a mobile wallet application. The primary user may be authenticated to the mobile wallet application to access the primary user profile of the mobile wallet application. While the primary user is logged in to the mobile wallet application, the computing platform may receive a request to access a secondary user profile. In response, the computing platform may generate and send a user interface including available secondary user profiles. The computing platform may receive selection of a first secondary user profile and may retrieve authentication requirements associated with the first secondary user profile.

The computing platform may transmit, to the user computing device, a request for authentication data based on the authentication requirements. The computing platform may receive authentication response data from the secondary user via the user computing device and may authenticate the secondary user to the secondary user profile of the mobile wallet application. The computing platform may generate and transmit, to the user computing device, a second user interface including options for transaction processing, may receive selection of an option and may process the transaction.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for implementing seamless authentication in a multi-profile mobile application in accordance with one or more aspects described herein;

FIGS. 2A-2E depict an illustrative event sequence for seamless authentication in a multi-profile mobile application in accordance with one or more aspects described herein;

FIG. 3 illustrates an illustrative method for seamless authentication in a multi-profile mobile application according to one or more aspects described herein;

FIGS. 4 and 5 illustrate example user interface that may be generated in accordance with one or more aspects described herein; and

FIG. 6 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed above, conventional mobile wallet applications do not generally allow for multiple user profiles on a same computing device. This can cause issues when a device is shared between users because each user accessing the mobile wallet application must log in to the application and a previous user must log out (or will automatically be logged out). In addition, use of the mobile wallet application may require set up each time a user who is not the primary user of the computing device attempts to access the mobile wallet application. Accordingly, aspects described herein provide for seamless authentication in a multi-profile mobile application.

As discussed more fully herein, the arrangements described provide for registration with a central hub (e.g., multi-profile computing platform 110) that may integrate with devices having various operating systems, as well as payment processing systems, to store authentication data, user profile data, customized rules associated with user profiles, and the like. This dedicated hardware component may be stored in a multi-cloud environment (e.g., to enable use by users of different cloud environments) and may enable multiple user profiles to coexist for use on a single computing device (e.g., smart phone or the like), with each user profile having its own partition. Accordingly, a primary user of a computing device may be logged in to, for instance, a mobile wallet application and may permit a secondary user to access their own mobile wallet via the mobile wallet application on the computing device of the primary user by logging in to a secondary user profile (e.g., while the primary user remains logged in). In some examples, the primary user may provide customized rules for authentication required to access the secondary user profile, transaction limits, time period in which a secondary user profile may be accessed (e.g., before expiration), and the like. Accordingly, the arrangements described herein provide for secure and seamless creation and management of multiple user profiles on a single user computing device.

These and various other arrangements will be discussed more fully below.

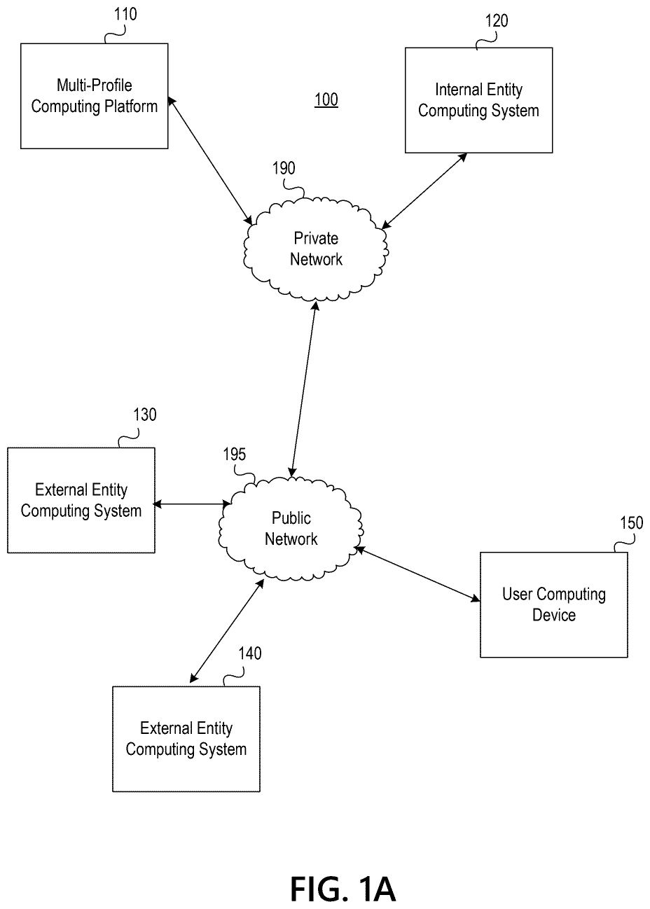

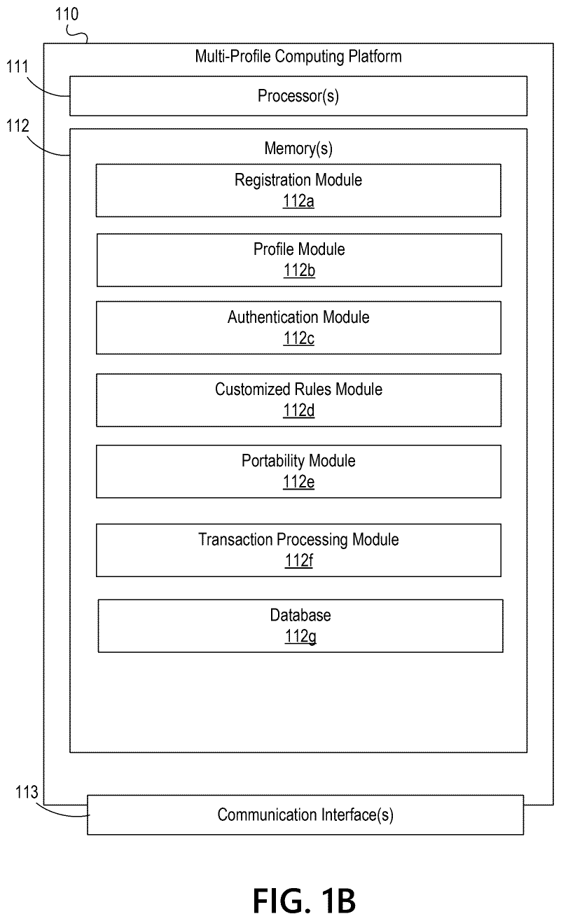

FIGS. 1A-1B depict an illustrative computing environment and devices for implementing seamless authentication for multi-profile mobile application in accordance with one or more aspects described herein. Referring to FIG. 1A, computing environment 100 may include one or more computing devices and/or other computing systems. For example, computing environment 100 may include multi-profile computing platform 110, internal entity computing system 120, external entity computing system 130, external entity computing system 140, and user computing device 150.

Although one internal entity computing system 120, two external entity computing systems 130, 140, and one user device 150 is shown, any number of systems or devices may be used without departing from the invention.

Multi-profile computing platform 110 may be include one or more computer components (e.g., servers, server blade, processor, memory, and the like) and may be configured to perform intelligent, dynamic, seamless authentication of multi-profile mobile applications. Multi-profile computing platform 110 may provide a central hub to act as a central processing unit, manage profiles, authenticate users, host transaction logic, and the like. For instance, multi-profile computing platform 110 may receive registration data from a user. The registration data may be associated with a user computing device of the user, who may be a primary user of the user computing device. In some examples, the registration data may include identification of one or more other secondary users who may execute one or more transaction using the user computing device but via a secondary user profile for a mobile wallet application executing on the user computing device. For instance, the primary user may register one or more secondary users and establish a secondary user profile for each secondary user in the mobile wallet or other mobile application. In some examples, each secondary user profile may be partitioned from the primary user profile and from the other secondary user profiles such that data cannot be shared across the profiles. Each secondary user profile may include one or more payment devices (e.g., payment cards, digital payment devices, or the like) that may be used by the corresponding secondary user on the user computing device of the primary user.

In some examples, the primary user may be authenticated to the user computing device. For instance, the primary user may login to the mobile wallet application executing on the user computing device. While the primary user is logged in, the multi-profile computing platform 110 may receive a request to allow a secondary user to execute a transaction using the user computing device (e.g., via a corresponding secondary user profile). In response, the multi-profile computing platform 110 may generate a first user interface including a plurality of selectable options, each selectable option associated with a different secondary user profile. In some examples, in generating the first user interface, the multi-profile computing platform 110 may evaluate each secondary profile to determine whether access allowed by the primary user to the user computing device has expired. If so, the first user interface will be generated without a selectable option corresponding to any expired user profiles. Accordingly, secondary users may be able to move between available secondary user profiles by accessing the first user interface on the user computing device 150.

The first user interface may be transmitted to the user computing device and displayed on a display of the user computing device. The multi-profile computing platform 110 may receive, from the user computing device, selection of a secondary user profile from the first user interface. In response to receiving the selection, the multi-profile computing platform 110 may retrieve authentication rules associated with the selected secondary user profile. For instance, one or more customized authentication rules may be established and stored by the multi-profile computing platform 110 for each secondary user profile. The customized authentication rules may, in some examples, be determined by the primary user and/or may be different from authentication rules established by the corresponding secondary user to access a mobile wallet application on the user computing device of the secondary user (e.g., a different user computing device on which the secondary user is the primary user).

The multi-profile computing platform 110 may transmit a request for authentication data based on the retrieved customized rules for the secondary user profile and may receive authentication response data from the user computing device in response. The multi-profile computing platform 110 may authenticate the secondary user. In response to authenticating the secondary user, the multi-profile computing platform 110 may generate a second user interface including options for selecting a transaction to process via the secondary user profile in the mobile wallet application. The multi-profile computing platform 110 may transmit the second user interface to the user computing device for display. In response, the multi-profile computing platform 110 may receive selection of a transaction to process and may process the transaction by interacting with one or more internal or external computing systems (e.g., internal computing system 120, external entity computing system 130, external entity computing system 140, or the like).

In some examples, multi-profile computing platform 110 may be configured to control access to and user of the various profiles. For instance, multi-profile computing platform 110 may be configured to interface with computing devices having various operating systems to facilitate access to multiple user profiles in a mobile wallet application. The multi-profile computing platform 110 may be configured to store and/or control authentication, accessibility, and the like, regardless of operating system being users. In some examples, the multi-profile computing platform 110 may be housed in a multi-cloud environment to enable interaction with various operating systems.

Internal entity computing system 120 may be or include one or more computer components (e.g., servers, server blades, memory, processors, or the like) and may host or execute one or more enterprise organization functions associated with transaction processing. For instance, internal entity computing system 120 may host or execute applications or systems associated with transferring funds to, from or between accounts, updating an account ledger, or the like.

External entity computing system 130 and/or external entity computing system 140 may be or include one or more computer components (e.g., servers, server blades, memory, processors, or the like) and may be associated with one or more transaction processing providers (e.g., credit card providers, digital or mobile payment providers, or the like), one or more retail locations (e.g., a point-of-sale system at a retailer), or the like. Accordingly, multi-profile computing platform 110 may interact with one or more of external entity computing system 130 and/or external entity computing system 140 to process transactions requested via the multi-profile computing platform 110.

User computing device 150 may be or include one or more computing devices, such as a laptop computer, smartphone, mobile device, wearable device, tablet device, or the like and may be configured to execute one or more mobile applications, including, for instance, a mobile wallet application. The user computing device 150 may receive user input via an input device (e.g., touch screen, keypad, or the like) to make selections, display user interfaces, and the like.

As mentioned above, computing environment 100 also may include one or more networks, which may interconnect one or more of multi-profile computing platform 110, internal entity computing system 120, external entity computing system 130, external entity computing system, and/or user computing device 150. For example, computing environment 100 may include private network 190. Private network 190 may include one or more sub-networks (e.g., Local Area Networks (LANs), Wide Area Networks (WANs), or the like). Private network 190 may interconnect one or more computing devices associated with the organization. For example, multi-profile computing platform 110 and internal entity computing system 120 may be connected via private network 190. Computing environment 100 may further include public network 195. Public network 195 may include one or more sub-networks (e.g., Local Area Networks (LANs), Wide Area Networks (WANs), or the like). Public network 195 may interconnect one or more computing devices outside the organization. For example, external entity computing system 130, external entity computing system 140, and/or user computing device 150 may be connected via public network 195, which may also connect external entity computing system 130, external entity computing system 140, and/or user computing device 150 to devices connected via the private network (e.g., multi-profile computing platform 110, internal entity computing system 120, and the like).

Referring to FIG. 1B, multi-profile computing platform 110 may include one or more processors 111, memory 112, and communication interface 113. A data bus may interconnect processor(s) 111, memory 112, and communication interface 113. Communication interface 113 may be a network interface configured to support communication between multi-profile computing platform 110 and one or more networks (e.g., network 190, network 195, or the like). Memory 112 may include one or more program modules having instructions that when executed by processor(s) 111 multi-profile computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of multi-profile computing platform 110 and/or by different computing devices that may form and/or otherwise make up multi-profile computing platform 110.

For example, memory 112 may have, store and/or include registration module 112a. Registration module 112a may store instructions and/or data that may cause or enable the multi-profile computing platform 110 to receive registration data associated with one or more user devices, associated primary users of the user devices and/or secondary users identified by the primary users. For instance, a primary user (e.g., a user associated with a user computing device such as user computing device 150 such that the primary user is the main user of the user computing device throughout a day, has control of apps downloaded to the user computing device 150, controls the appearance of one or more displays of the user computing device 150, and the like) may request to register one or more computing devices, such as user computing device 150, with the multi-profile computing platform 110. In some examples, the user computing device 150 may be a smart phone of the primary user. In some arrangements, additional user computing devices, such as a wearable device, tablet device, of the like, for which the primary user is also the primary user, may be registered. The registration data may include identification of the primary user, a primary user profile associated with the primary user (e.g., a mobile wallet application profile associated with the primary user that may include, for instance, one or more payment devices associated with the primary user), a phone number associated with user computing device 150, a unique device identifier associated with each user computing device, and the like.

Further, the primary user may identify one or more secondary users that may be given temporary or limited access to the user computing device 150. For instance, the primary user may identify one or more secondary users (e.g., users who are not the primary or main user of user computing device 150, users to do not typically use user computing device 150 to perform transactions or other functions, users who may be a primary user of another smart phone, or the like) who may, at times, be given temporary access to the user computing device 150 to execute one or more transaction using a user profile associated with each secondary user.

Multi-profile computing platform 110 may further have, store and/or include profile module 112b. Profile module 112b may store instructions and/or data that may cause or enable the multi-profile computing platform 110 to store one or more user profiles. For instance, profile module 112b may store primary user profile associated with the primary user and including digital payment devices associated with the primary user. In some examples, profile module 112b may store one or more secondary user profiles associated with each secondary user identified by the primary user and including one or more digital payment devices associated with a respective secondary user. Each profile (e.g., primary user profile, each secondary user profile, or the like) may retain its settings, payment methods, rules, and the like, to ensure a seamless user experience. In some examples, the profiles may be provided to the user computing device 150 for use in executing one or more transactions and each profile may be partitioned from each other profile to ensure data is not transmitted between profiles. The primary and/or secondary user profiles may be established at the multi-profile computing platform 110 (e.g., each profile may be set up at the multi-profile computing platform 110) or the profiles may be ported (e.g., via near-field communication, Bluetooth, or other communication protocol) from a computing device to the multi-profile computing platform 110 (e.g., a primary user may port a profile from the primary user computing device 150 and/or one or more secondary users may port a respective profile from their respective computing devices on which they are the primary user, or the like). In some examples, the secondary profiles may be associated with a child or dependent of the primary user, a business associate of the primary user, an employee of the primary user, or the like. In some examples, one or more profiles stored by the profile module 112b of the multi-profile computing platform 110 may be ported from the multi-profile computing platform 110 to user computing device 150 for use as a secondary user profile on the device (e.g., for a pre-determined or temporary period).

Multi-profile computing platform 110 may further have, store and/or include authentication module 112c. Authentication module 112c may store instructions and/or data that may cause or enable the multi-profile computing platform 110 to store authentication data associated with the primary user, as well as the one or more secondary users. For instance, authentication module 112c may store usernames, passwords, biometric data, and the like, associated with authenticating the primary user, as well as the one or more secondary users to the mobile application (e.g., the mobile wallet application). Accordingly, authentication of the primary user and one or more secondary users may be performed by the multi-profile computing platform 110. In some examples, biometric tokens may be ported from other devices (e.g., user computing device of the primary user, user computing device of the one or more secondary user, or the like) for temporary use via text, near-field communication, Bluetooth, or the like.

Multi-profile computing platform 110 may further have, store and/or include customized rules module 112d. Customized rules module 112d may store instructions and/or data that may cause or enable the multi-profile computing platform 110 to receive, from the primary user, one or more customized rules controlling various aspects of the secondary user profiles, use of the user computing device when a secondary user profile is being accessed (e.g., a secondary user is logged in to a respective secondary user profile on the user computing device 150), or the like. For instance, a primary user may identify one or more requirements for authentication for one or more secondary users. In some examples, the requirements for authentication for a secondary user may be different from requirements established for authentication of the secondary user on the secondary user's primary device (e.g., when logging in to the mobile wallet application on the secondary user's primary device). Accordingly, the primary user may customize authentication rules for each secondary user to log in to the secondary user profile on the primary device (e.g., user computing device 150) of the primary user. For instance, a secondary user may rely solely on biometric authentication to log in to their primary profile on their primary device. However, when logging into the secondary user profile on the user computing device 150, the primary user may require multi-factor authentication. This may provide additional control for the primary user.

Further, the primary user may store, in customized rules module 112d, one or more rules for controlling transactions performed by the one or more secondary users via the secondary user profile. For instance, the primary user may identify a type of transaction, amount of transaction, or the like, as well as various limits for each (e.g., a particular secondary user can only process certain types of transactions via the user computing device 150, a particular secondary user can only process transactions below a threshold amount using the user computing device 150, or the like).

In some examples, the primary user may input the customized rules to the customized rules module 112d. Additionally or alternatively, the rules may be imported to the customized rules module 112d based on pre-existing rules established for one or more payment devices (e.g., limits on credit cards, or the like).

Multi-profile computing platform 110 may further have, store and/or include portability module 112e. Portability module 112e may store instructions and/or data that may cause or enable the multi-profile computing platform 110 to store identification of limits on availability of one or more secondary user profiles. For instance, a primary user may identify a secondary user and associated profile as eligible to execute transactions via user computing device 150 for a predetermined time period, after which the secondary user profile might not be available. Further, in some examples, portability module 112e may execute one or more instructions causing data associated with a secondary user profile, one or more transactions performed via the secondary user profile on the user computing device 150, or the like, to be deleted or removed after a predetermined time, upon completion of the transaction, or the like.

Multi-profile computing platform 110 may further have, store and/or include transaction processing module 112f. Transaction processing module 112f may store instructions and/or data that may cause or enable the multi-profile computing platform 110 to execute or process one or more transactions via one or more additional systems. For instance, transaction processing module 112f may interact with internal entity computing system 120, external entity computing system 130 and/or external entity computing system 140 to process the transaction, transfer funds, modify an account ledger, or the like.

Multi-profile computing platform 110 may further have, store and/or include database 112g. Database 112g may further store data related to user profiles, registered devices, customized rules, portability, and/or other data to perform the functions of the multi-profile computing platform 110.

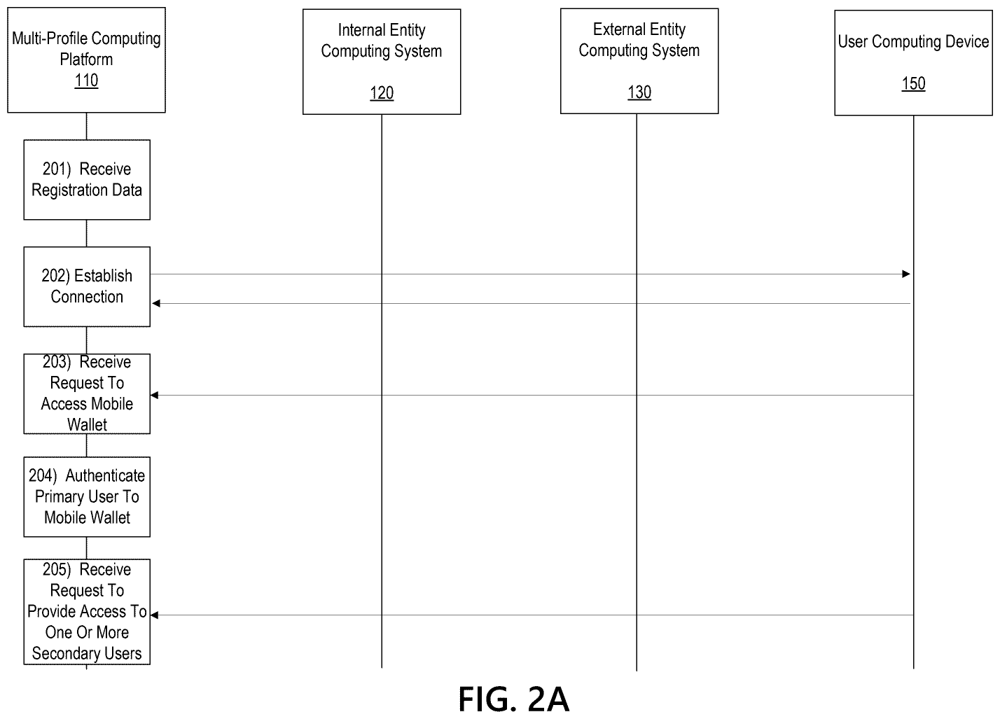

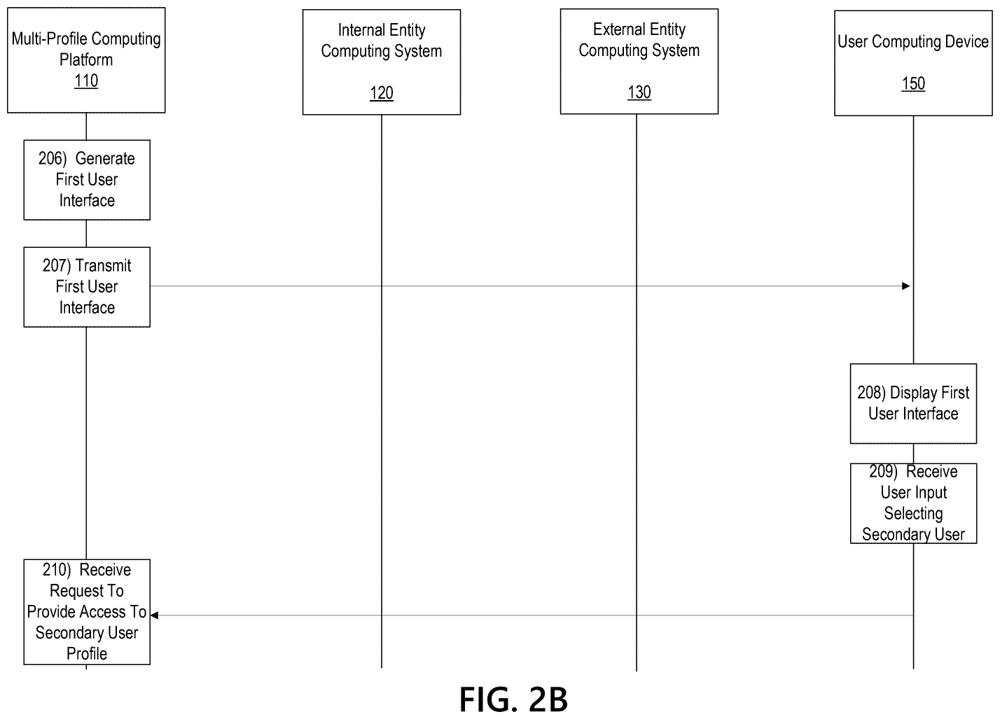

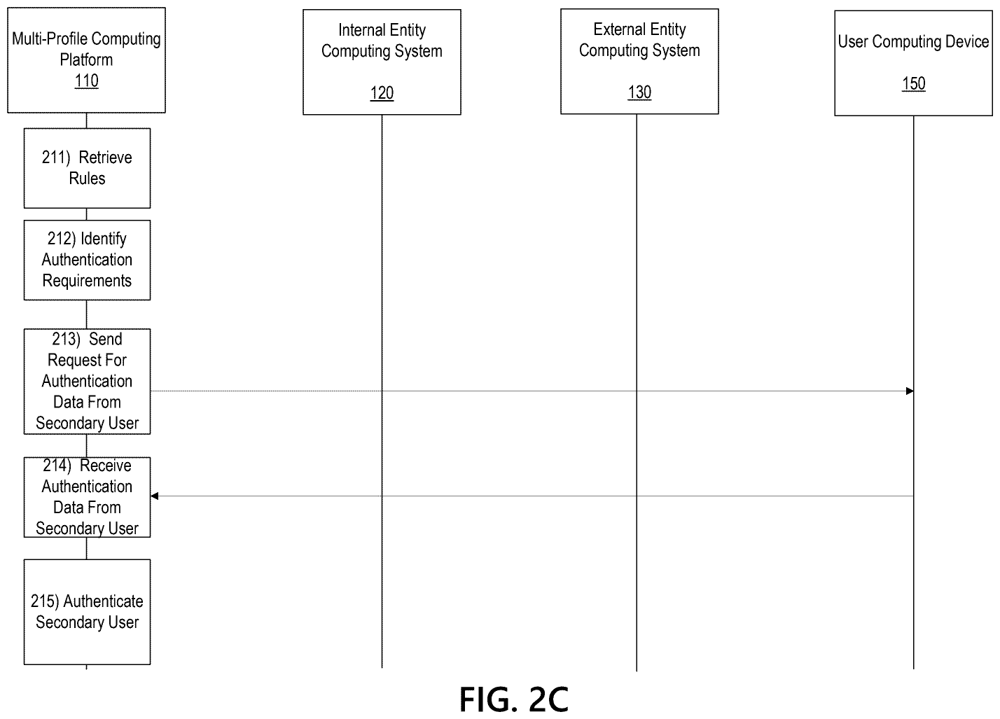

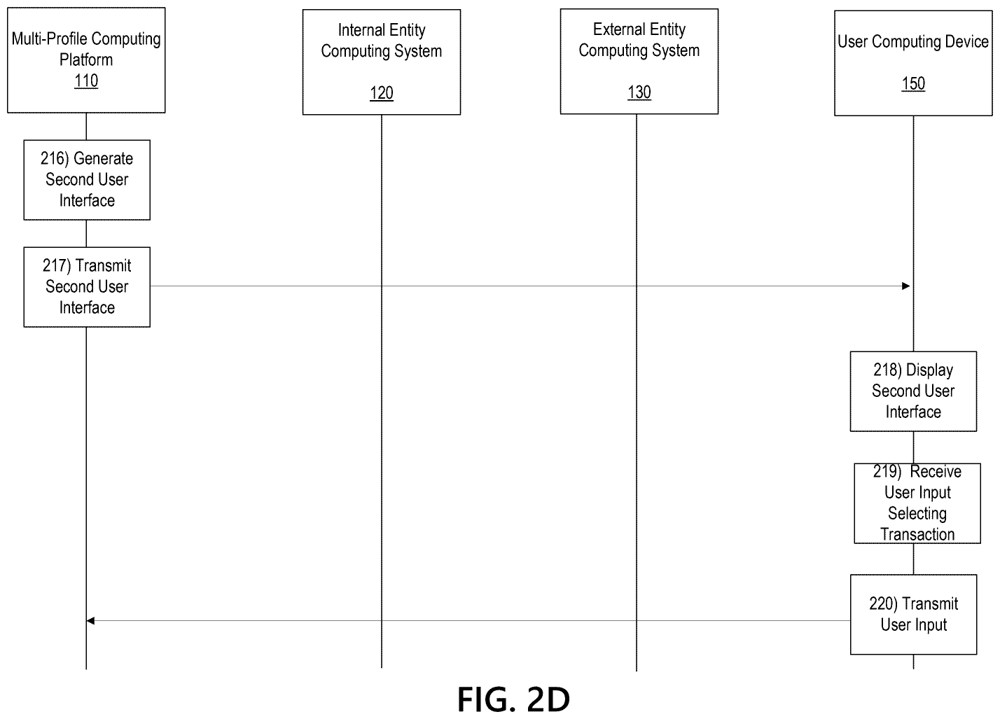

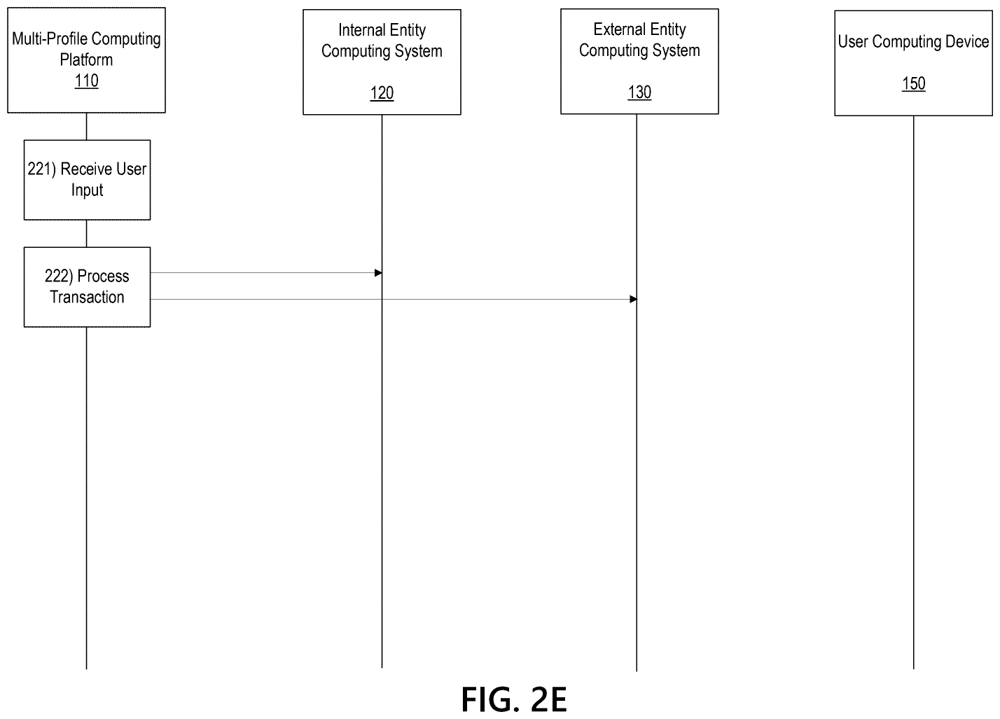

FIGS. 2A-2E depict one example illustrative event sequence for seamless authentication in a multi-profile mobile application in accordance with one or more aspects described herein. The events shown in the illustrative event sequence are merely one example sequence and additional events may be added, or events may be omitted, without departing from the invention. Further, one or more processes discussed with respect to FIGS. 2A-2E may be performed in real-time or near real-time.

With reference to FIG. 2A, at step 201, multi-profile computing platform 110 may receive registration data. For instance, multi-profile computing platform 110 may receive registration data from a user computing device 150 of a primary user. The registration data may include identification of the user, identification of one or more user computing devices associated with the user, a primary user profile and identification of one or more secondary user profiles associated with one or more secondary users.

At step 202, multi-profile computing platform 110 may establish a connection with user computing device 150. For instance, multi-profile computing platform 110 may establish a first wireless data connection with user computing device 150. Upon establishing the first data wireless connection, a communication session may be initiated between multi-profile computing platform 110 and user computing device 150.

At step 203, multi-profile computing platform 110 may receive a request to access a mobile wallet application executing on the user computing device 150. The request may be received from the user computing device 150 and initiated by a primary user of the user computing device. In some examples, the request to access the mobile wallet application may include authentication information associated with the primary user of the user computing device 150 (e.g., username and password, biometric data, personal identification number, or the like).

At step 204, multi-profile computing platform 110 may authenticate the primary user to the mobile wallet application executing on the user computing device 150. For instance, the multi-profile computing platform 110 may compare the authentication received at step 203 to pre-stored authentication data to determine whether the primary user is authenticated and provide access to the primary user profile associated with the primary user in the mobile wallet application. If the primary user is not authenticated, the process may end. If the primary user is authenticated, the primary user may be logged in to the mobile wallet application (e.g., to access the primary user profile) and the process may proceed to step 205.

At step 205, multi-profile computing platform 110 may receive a request to provide access to a secondary user profile in the mobile wallet application executing on the user computing device 150. For instance, multi-profile computing platform 110 may receive, from the user computing device 150 and while the primary user is logged in to the mobile wallet application, a request to provide access to a secondary user profile associated with a secondary user of the user computing device 150 in the mobile wallet application.

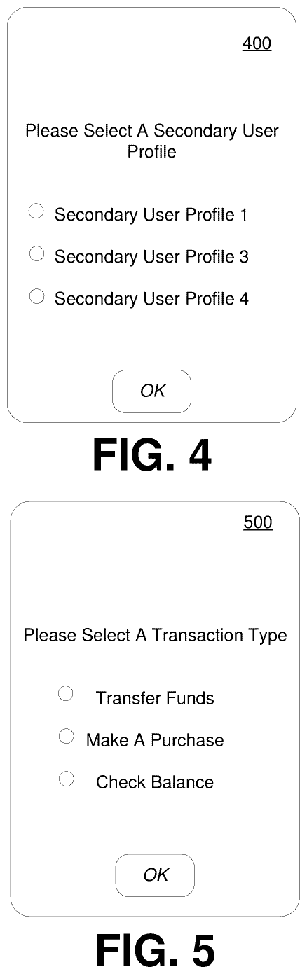

With reference to FIG. 2B, at step 206, multi-profile computing platform 110 may generate a first user interface including a selectable option associated with each secondary user profile available on the user computing device 150. In some examples, generating the first user interface may include evaluating portability rules associated with each secondary user profile to determine whether the profile has expired or is not longer available for access via the user computing device 150. Accordingly, based on evaluating availability of each secondary user profile, multi-profile computing platform 110 may generate a first user interface displaying the available secondary user profiles and including a selectable option associated with each available secondary user profile (i.e., expired secondary user profiles might not be shown in the generated first user interface). FIG. 4 illustrates one example first user interface 400 that includes three secondary user profiles and a selectable option (e.g., radio button, for example) associated with each. Although three secondary user profiles are shown, more or fewer may be shown without departing from the invention.

With further reference to FIG. 2B, at step 207, multi-profile computing platform 110 may transmit or send the first user interface to the user computing device 150. In some examples, transmitting or sending the first user interface may cause the first user interface to be displayed on a display of the user computing device 150.

At step 208, user computing device 150 may receive and display the first user interface.

At step 209, user computing device 150 may receive user input selecting a secondary user profile from the displayed secondary user profiles in the first user interface. For instance, a secondary user operating user computing device 150 may select the secondary user profile associated with that secondary user.

At step 210, the user input selecting the secondary user profile may be transmitted by the user computing device to the multi-profile computing platform 110 and received by the multi-profile computing platform 110. The user input may include a request to access the selected secondary user profile on the mobile wallet application via the user computing device 150 (and while the primary user is logged in to the mobile wallet application via the primary user profile).

With reference to FIG. 2C, at step 211, multi-profile computing platform 110 may retrieve one or more customized rules associated with the selected secondary user profile. For instance, one or more authentication requirement rules, transaction rules, and the like may be retrieved for the selected secondary user profile.

At step 212, based on the retrieved customized rules associated with the selected secondary user profile, multi-profile computing platform 110 may identify one or more authentication requirements for accessing the selected secondary user profile via the mobile wallet application executing on the user computing device 150 (and, in at least some examples, while the primary user is logged in to the mobile wallet application executing on the user computing device 150.

At step 213, based on the identified authentication requirements, multi-profile computing platform 110 may transmit or send, to the user computing device 150, a request for authentication data from the secondary user to access the selected secondary user profile.

At step 214, the multi-profile computing platform 110 may receive, from the user computing device 150, authentication response data in response to the request for authentication data to access the selected secondary user profile.

At step 215, the multi-profile computing platform 110 may authenticate the secondary user to provide access to the selected secondary user profile. For instance, the multi-profile computing platform 110 may compare the received authentication response data to pre-stored authentication data to determine whether the secondary user is authenticated to the secondary user profile in the mobile wallet application executing on the user computing device 150. If not, the process may end. If so, the process may proceed to step 216 in FIG. 2D. In some examples, successful authentication of the secondary user to the secondary user profile may cause the multi-profile computing platform 110 to port the secondary user profile to the user computing device 150 for a temporary period in order to enable the secondary user to execute a desired transaction using the secondary user profile on the user computing device 150. After the time period, the secondary user profile may be deleted or otherwise removed from the user computing device 150.

With reference to FIG. 2D, at step 216, multi-profile computing platform 110 may generate a second user interface including a plurality of transaction options for the secondary user to access. For instance, the second user interface may include options to transfer funds, make a payment, make a purchase, or the like. In some examples, in generating the second user interface, multi-profile computing platform 110 may access the customized rules for the selected secondary user profile and may generate a user interface including only types of transactions authorized based on the rules for that secondary user profile. FIG. 5 illustrates one example second user interface 500 that may be generated. The interface 500 includes options to make a purchase, transfer funds and check and account balance, as well as a selectable option (e.g., radio button or other selectable option) to select a transaction from the available types of transactions. More or fewer options may be used without departing from the invention.

At step 217, multi-profile computing platform 110 may transmit or send the second user interface to the user computing device 150. In some examples, transmitting or sending the second user interface may cause the second user interface to be displayed by a display of the user computing device 150.

At step 218, user computing device 150 may receive the second user interface and display the second user interface.

At step 219, the user computing device 150 may receive user input selecting a transaction from the list of available transactions displayed on the second user interface.

At step 220, user computing device 150 may transmit or send the selection of the type of transaction to the multi-profile computing platform 110.

Although only two user interfaces are shown and described as being generated, additional user interfaces may be generated to request additional information related to the transaction processing (e.g., a purchase to be made, an amount of funds to transfer, or the like).

With reference to FIG. 2E, at step 221, multi-profile computing platform 110 may receive the user input selecting the type of transaction. At step 222, the multi-profile computing platform 110 may process the requested transaction. In some examples, processing the requested transaction may include interacting with one or more additional systems or devices, such as internal entity computing system 120, external entity computing system 130, or the like, to complete the transaction (e.g., transfer funds, update an account ledger, complete a purchase, or the like).

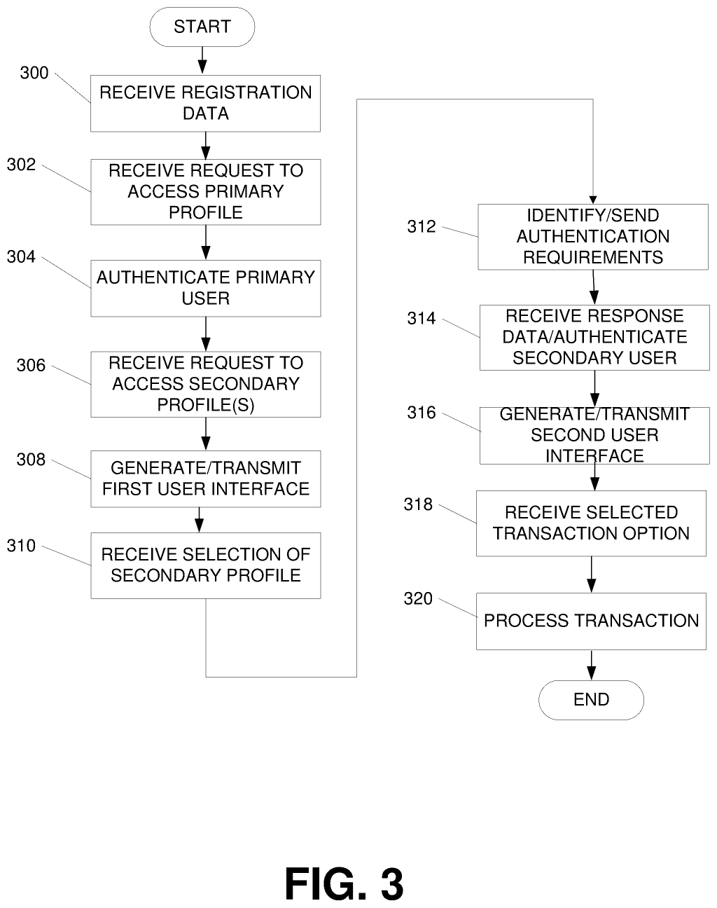

FIG. 3 is a flow chart illustrating one example method of seamless authentication in a multi-profile application in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, multi-profile computing platform 110 may receive registration data. For instance, multi-profile computing platform 110 may receive, from a user computing device associated with a primary user, identification of the user computing device, the primary user and/or one or more secondary users. In some examples, user profiles associated with the primary user and secondary users may be received.

At step 302, multi-profile computing platform 110 may receive, from the user computing device, a request to access a primary user profile of a mobile wallet application executing on the user computing device. In some examples, the request may be received from the primary user of the user computing device and may include authentication data associated with the primary user and the primary user profile.

At step 304, multi-profile computing platform 110 may authenticate the primary user to the primary user profile of the mobile wallet application executing on the user computing device. In some examples, authenticating the user may include comparing the authentication data to pre-stored data to determine whether the data matches. In some arrangements, authenticating the primary user to the primary user profile of the mobile wallet application executing on the user computing device may include logging the primary user in to the primary user profile and providing access to the primary user profile via the user computing device. The process may then continue with the following steps that may, in some examples, occur while the primary user is logged in to the primary user profile of the mobile wallet application executing on the user computing device.

At step 306, multi-profile computing platform 110 may receive, from the user computing device, a request to access a secondary user profile of the mobile wallet application and associated with a secondary user of the one or more secondary users.

In response to receiving the request, at step 308, multi-profile computing platform 110 may generate a first user interface including available secondary user profiles of the mobile wallet application and a selectable option associated with each secondary user profile. The available secondary user profiles may include the secondary user profile. In some examples, generating the first user interface may include evaluating each secondary user profile to determine whether a respective secondary user profile has expired and generating the first user interface including only secondary user profiles that have not expired. The multi-profile computing platform 110 may transmit or send the first user interface to the user computing device which may cause the user computing device to display the first user interface.

At step 310, multi-profile computing platform 110 may receive selection of the secondary user profile from the user computing device and via the first user interface.

At step 312, based on the received selection of the secondary user interface, multi-profile computing platform 110 may identify, based on one or more rules associated with the secondary user profile, one or more authentication requirements to authenticate the secondary user to the secondary user profile of the mobile wallet application executing on the user computing device. In some examples, the authentication requirements may be determined by the primary user and may apply to authentication of the secondary user to the secondary user profile on the user computing device 150 (e.g., the authentication requirements may be unique to the secondary user profile on the user computing device 150 and authenticating the secondary user on other devices may have different authentication requirements). Additionally or alternatively, the authentication requirements may be unique to the secondary user profile. The multi-profile computing platform 110 may send a request for authentication data, based on the identified authentication requirements, to the user computing device 150.

At step 314, multi-profile computing platform 110 may receive authentication response data from the secondary user via the user computing device 150. Multi-profile computing platform 110 may authenticate the secondary user to the secondary user profile of the mobile wallet application executing on the user computing device based on the authentication response data.

At step 316, multi-profile computing platform 110 may, in response to authenticating the secondary user to the secondary user profile, generate a second user interface. The second user interface may include a plurality of options for executing a transaction via the secondary user profile (e.g., via one or more payment devices stored in the secondary user profile) of the mobile wallet application executing on the user computing device. In some examples, the second user interface may be generated based on one or more identified customized rules associated with the secondary user profile (e.g., transaction types allowed, limits on transaction amounts, or the like). The multi-profile computing platform 110 may transmit or send the second user interface to the user computing device 150 which may cause the second user interface to be displayed by a display of the user computing device 150.

At step 318, multi-profile computing platform 110 may receive, from the user computing device, selection of an option of the plurality of options for executing the transaction.

At step 320, multi-profile computing platform 110 may process the transaction. In some examples, processing the transaction may include processing the transaction using a payment device stored in the secondary user profile and via the user computing device 150. In some arrangements, processing the transaction may include the multi-profile computing platform 110 interacting with one or more other systems or devices (e.g., a point-of-sale system, a credit card processing system, or the like, such as via internal entity computing system 120, external entity computing system 130, external entity computing system 140, or the like).

As discussed herein, the arrangements described provide for seamless authentication of multiple users to, for instance, a mobile wallet application on a single user computing device. Use of the centralized hub (e.g., multi-profile computing platform 110) to control and manage profiles, authentication, transaction processing, and the like, ensures a secure, efficient process for using more than one profile on a single device. Use of multiple profiles that are partitioned from each other ensures data privacy and control of visible content between users.

As discussed herein, one or more customized rules may be established for each secondary user profile. In some examples, the primary user may be a parent and rules may be established for secondary user profiles associated with one or more children. In another example, the secondary user may be an employee of the primary user and the primary user may establish rules related to types of transactions to process, amount of transaction, or the like.

In some examples, the established rules may include authentication requirements associated with a secondary user profile. In some examples, the primary user may require real-time approval of the access to the secondary user profile after the secondary user is authenticated to the secondary user profile but before the secondary user is provided access to the secondary user profile of the mobile wallet application. For instance, after the secondary user has been authenticated, but before access is provided, a real-time notification may be sent to the user computing device 150 or another registered computing device of the primary user (e.g., via text, email, or the like) that may require approval or acknowledgment by the primary user before access may be provided to the secondary user profile. In some examples, this real-time approval may be established for different types of transactions, transaction amounts, or the like.

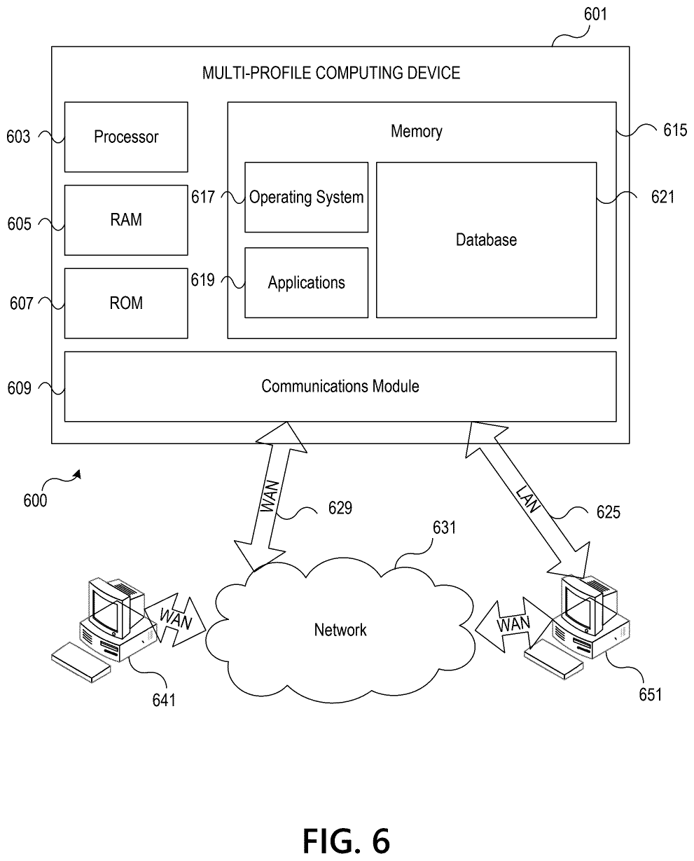

FIG. 6 depicts an illustrative operating environment in which various aspects of the present disclosure may be implemented in accordance with one or more example embodiments. Referring to FIG. 6, computing system environment 600 may be used according to one or more illustrative embodiments. Computing system environment 600 is only one example of a suitable computing environment and is not intended to suggest any limitation as to the scope of use or functionality contained in the disclosure. Computing system environment 600 should not be interpreted as having any dependency or requirement relating to any one or combination of components shown in illustrative computing system environment 600.

Computing system environment 600 may include multi-profile computing device 601 having processor 603 for controlling overall operation of multi-profile computing device 601 and its associated components, including Random Access Memory (RAM) 605, Read-Only Memory (ROM) 607, communications module 609, and memory 615. Multi-profile computing device 601 may include a variety of computer readable media. Computer readable media may be any available media that may be accessed by multi-profile computing device 601, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by multi-profile computing device 601.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor (e.g., hardware processor) on multi-profile computing device 601. Such a processor may execute computer-executable instructions stored on a computer-readable medium.

Software may be stored within memory 615 and/or storage to provide instructions to processor 603 for enabling multi-profile computing device 601 to perform various functions as discussed herein. For example, memory 615 may store software used by multi-profile computing device 601, such as operating system 617, application programs 619, and associated database 621. Also, some or all of the computer executable instructions for multi-profile computing device 601 may be embodied in hardware or firmware. Although not shown, RAM 605 may include one or more applications representing the application data stored in RAM 605 while multi-profile computing device 601 is on and corresponding software applications (e.g., software tasks) are running on multi-profile computing device 601.

Communications module 609 may include a microphone, keypad, touch screen, and/or stylus through which a user of multi-profile computing device 601 may provide input, and may also include one or more of a speaker for providing audio output and a video display device for providing textual, audiovisual and/or graphical output. Computing system environment 600 may also include optical scanners (not shown).

Multi-profile computing device 601 may operate in a networked environment supporting connections to one or more remote computing devices, such as computing devices 641 and 651. Computing devices 641 and 651 may be personal computing devices or servers that include any or all of the elements described above relative to multi-profile computing device 601.

The network connections depicted in FIG. 6 may include Local Area Network (LAN) 625 and Wide Area Network (WAN) 629, as well as other networks. When used in a LAN networking environment, multi-profile computing device 601 may be connected to LAN 625 through a network interface or adapter in communications module 609. When used in a WAN networking environment, multi-profile computing device 601 may include a modem in communications module 609 or other means for establishing communications over WAN 629, such as network 631 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
a memory storing computer-readable instructions that, when executed by the at least one processor, cause the computing platform to:
receive, from a user computing device associated with a primary user, a request for registration, wherein the request for registration includes identification of the user computing device, the primary user, and one or more secondary users;
receive, from the user computing device, a request to access a primary user profile of a mobile wallet application executing on the user computing device, wherein the request to access the primary user profile is received from the primary user of the user computing device and includes authentication data associated with the primary user and the primary user profile;
authenticate, based on the authenticated data associated with the primary user and the primary user profile, the primary user to the primary user profile of the mobile wallet application executing on the user computing device, wherein authenticating the primary user to the primary user profile includes logging the primary user in to the primary user profile and providing access to the primary user profile via the user computing device;
while the primary user is logged in to the primary user profile of the mobile wallet application executing on the user computing device:
receive, from the user computing device, a request to access a secondary user profile of the mobile wallet application and associated with a secondary user of the one or more secondary users;
generate a first user interface including available secondary user profiles of the mobile wallet application and a selectable option associated with each available secondary user profile of the mobile wallet application, wherein the available secondary user profiles include the secondary user profile;
transmit, to the user computing device, the first user interface, wherein transmitting the first user interface to the user computing device causes the user computing device to display the first user interface on a display of the user computing device;
receive, from the user computing device, selection of the secondary user profile associated with the secondary user;
identify, based on one or more rules for the secondary user profile, one or more authentication requirements to authenticate the secondary user to the secondary user profile of the mobile wallet application;
transmit, to the user computing device and based on the one or more authentication requirements, authentication response data from the secondary user;
receive, from the user computing device, the authentication response data of the secondary use;
authenticate the secondary user to the secondary user profile of the mobile wallet application based on the authentication response data;
in response to authenticating the secondary user, generate a second user interface including a plurality of options for executing a transaction via the secondary user profile of the mobile wallet application executing on the user computing device;
transmit, to the user computing device, the second user interface, wherein transmitting the second user interface causes the user computing device to display the second user interface on the display of the user computing device;
receive, from the user computing device, selection of an option of the plurality of options for executing the transaction; and
process the transaction.

2. The computing platform of claim 1, wherein the authentication requirements to authenticate the secondary user to the secondary user profile of the mobile wallet application are determined by the primary user and stored by the computing platform.

3. The computing platform of claim 1, wherein the authentication requirements are unique to the secondary user profile.

4. The computing platform of claim 1, wherein executing the transaction including executing the transaction using a payment device stored in the secondary user profile and associated with the secondary user.

5. The computing platform of claim 1, wherein the primary user profile is partitioned from the secondary user profile.

6. The computing platform of claim 1, wherein generating the first user interface including available secondary user profiles of the mobile wallet application includes evaluating each secondary user profile to determine whether a respective secondary user profile has expired and generating the first user interface including only secondary user profiles that have not expired.

7. The computing platform of claim 1, further including instructions that, when executed, cause the computing platform to:
while the primary user is logged in to the primary user profile of the mobile wallet application executing on the user computing device:
identify one or more customized rules associated with the secondary user profile,
wherein generating the second user interface includes generating the plurality of options based on the identified one or more customized rules associated with the secondary user profile.

8. A method, comprising:
receiving, by a computing platform, the computing platform having at least one processor, and memory, and from a user computing device associated with a primary user, a request for registration, wherein the request for registration includes identification of the user computing device, the primary user, and one or more secondary users;
receiving, by the at least one processor and from the user computing device, a request to access a primary user profile of a mobile wallet application executing on the user computing device, wherein the request to access the primary user profile is received from the primary user of the user computing device and includes authentication data associated with the primary user and the primary user profile;
authenticating, by the at least one processor and based on the authenticated data associated with the primary user and the primary user profile, the primary user to the primary user profile of the mobile wallet application executing on the user computing device, wherein authenticating the primary user to the primary user profile includes logging the primary user in to the primary user profile and providing access to the primary user profile via the user computing device;
while the primary user is logged in to the primary user profile of the mobile wallet application executing on the user computing device:
receiving, by the at least one processor and from the user computing device, a request to access a secondary user profile of the mobile wallet application and associated with a secondary user of the one or more secondary users;
generating, by the at least one processor, a first user interface including available secondary user profiles of the mobile wallet application and a selectable option associated with each available secondary user profile of the mobile wallet application, wherein the available secondary user profiles include the secondary user profile;
transmitting, by the at least one processor and to the user computing device, the first user interface, wherein transmitting the first user interface to the user computing device causes the user computing device to display the first user interface on a display of the user computing device;
receiving, by the at least one processor and from the user computing device, selection of the secondary user profile associated with the secondary user;
identifying, by the at least one processor and based on one or more rules for the secondary user profile, one or more authentication requirements to authenticate the secondary user to the secondary user profile of the mobile wallet application;
transmitting, by the at least one processor and to the user computing device and based on the one or more authentication requirements, authentication response data from the secondary user;
receiving, by the at least one processor and from the user computing device, the authentication response data of the secondary use;
authenticating, by the at least one processor, the secondary user to the secondary user profile of the mobile wallet application based on the authentication response data;
in response to authenticating the secondary user, generating, by the at least one processor, a second user interface including a plurality of options for executing a transaction via the secondary user profile of the mobile wallet application executing on the user computing device;
transmitting, by the at least one processor and to the user computing device, the second user interface, wherein transmitting the second user interface causes the user computing device to display the second user interface on the display of the user computing device;
receiving, by the at least one processor and from the user computing device, selection of an option of the plurality of options for executing the transaction; and
processing, by the at least one processor, the transaction.

9. The method of claim 8, wherein the authentication requirements to authenticate the secondary user to the secondary user profile of the mobile wallet application are determined by the primary user and stored by the computing platform.

10. The method of claim 8, wherein the authentication requirements are unique to the secondary user profile.

11. The method of claim 8, wherein executing the transaction including executing the transaction using a payment device stored in the secondary user profile and associated with the secondary user.

12. The method of claim 8, wherein the primary user profile is partitioned from the secondary user profile.

13. The method of claim 8, wherein generating the first user interface including available secondary user profiles of the mobile wallet application includes evaluating each secondary user profile to determine whether a respective secondary user profile has expired and generating the first user interface including only secondary user profiles that have not expired.

14. The method of claim 8, further including:
while the primary user is logged in to the primary user profile of the mobile wallet application executing on the user computing device:
identifying, by the at least one processor, one or more customized rules associated with the secondary user profile,
wherein generating the second user interface includes generating the plurality of options based on the identified one or more customized rules associated with the secondary user profile.

15. One or more non-transitory computer-readable media storing instructions that, when executed by a computing platform comprising at least one processor, memory, and a communication interface, cause the computing platform to:
receive, from a user computing device associated with a primary user, a request for registration, wherein the request for registration includes identification of the user computing device, the primary user, and one or more secondary users;
receive, from the user computing device, a request to access a primary user profile of a mobile wallet application executing on the user computing device, wherein the request to access the primary user profile is received from the primary user of the user computing device and includes authentication data associated with the primary user and the primary user profile;
authenticate, based on the authenticated data associated with the primary user and the primary user profile, the primary user to the primary user profile of the mobile wallet application executing on the user computing device, wherein authenticating the primary user to the primary user profile includes logging the primary user in to the primary user profile and providing access to the primary user profile via the user computing device;
while the primary user is logged in to the primary user profile of the mobile wallet application executing on the user computing device:
receive, from the user computing device, a request to access a secondary user profile of the mobile wallet application and associated with a secondary user of the one or more secondary users;
generate a first user interface including available secondary user profiles of the mobile wallet application and a selectable option associated with each available secondary user profile of the mobile wallet application, wherein the available secondary user profiles include the secondary user profile;
transmit, to the user computing device, the first user interface, wherein transmitting the first user interface to the user computing device causes the user computing device to display the first user interface on a display of the user computing device;
receive, from the user computing device, selection of the secondary user profile associated with the secondary user;
identify, based on one or more rules for the secondary user profile, one or more authentication requirements to authenticate the secondary user to the secondary user profile of the mobile wallet application;
transmit, to the user computing device and based on the one or more authentication requirements, authentication response data from the secondary user;
receive, from the user computing device, the authentication response data of the secondary use;
authenticate the secondary user to the secondary user profile of the mobile wallet application based on the authentication response data;
in response to authenticating the secondary user, generate a second user interface including a plurality of options for executing a transaction via the secondary user profile of the mobile wallet application executing on the user computing device;
transmit, to the user computing device, the second user interface, wherein transmitting the second user interface causes the user computing device to display the second user interface on the display of the user computing device;
receive, from the user computing device, selection of an option of the plurality of options for executing the transaction; and
process the transaction.

16. The one or more non-transitory computer-readable media of claim 15, wherein the authentication requirements to authenticate the secondary user to the secondary user profile of the mobile wallet application are determined by the primary user and stored by the computing platform.

17. The one or more non-transitory computer-readable media of claim 15, wherein the authentication requirements are unique to the secondary user profile.

18. The one or more non-transitory computer-readable media of claim 15, wherein executing the transaction including executing the transaction using a payment device stored in the secondary user profile and associated with the secondary user.

19. The one or more non-transitory computer-readable media of claim 15, wherein generating the first user interface including available secondary user profiles of the mobile wallet application includes evaluating each secondary user profile to determine whether a respective secondary user profile has expired and generating the first user interface including only secondary user profiles that have not expired.

20. The one or more non-transitory computer-readable media of claim 15, further including instructions that, when executed, cause the computing platform to:
while the primary user is logged in to the primary user profile of the mobile wallet application executing on the user computing device:
identify one or more customized rules associated with the secondary user profile,
wherein generating the second user interface includes generating the plurality of options based on the identified one or more customized rules associated with the secondary user profile.
